(19) United States
(12) Patent Application Publication
(10) Pub. No.: US 2005/0001923 A1
(43) Pub. Date: Jan. 6, 2005

(54) Digital camera module

(76) Inventors: Tsung-Wei Chiang, Tu-Chen (TW); Ming-Chiang Tsai, Tu-Chen (TW); Chun Yu Lee, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/886,107

(22) Filed: Jul. 6, 2004

(30) Foreign Application Priority Data
Jul. 4, 2003 (TW) 92212392

(51) Int. Cl. H04N 5/225

(52) U.S. Cl. 348/340

(57) ABSTRACT

A digital camera module (1) includes a drawtube (2), a holder (3), a baseboard (4), a connector (42) attached on the baseboard, and several conductive terminals (36) embedded in the holder. The drawtube is held in the holder, and the holder is electrically connected with the baseboard by the connector. The digital camera module can be connected with an external device such as a portable electronic device via the terminals without the need for any extra parts. Thus a thickness and size of the digital camera module is reduced, making it more readily inserted into devices such as mobile phones.

### BACKGROUND OF THE INVENTION

1. Field of the Invention

The present invention generally relates to digital camera modules, and more particularly to a digital camera module for a portable electronic device.

2. Prior Art

Currently, a flexible printed circuit (FPC) is often provided for a digital camera module to connect it with a portable electronic device. For example, a typical digital camera module includes a lens, a lens holder, a baseboard, and two electronic devices embedded on the baseboard. The electronic devices may be an electro-optical device and an analog-to-digital converter (A/D converter), for transforming incident light into analog signals and then into digital signals. An FPC is provided to connect the digital camera module with other electronic devices. Because of this structure, an overall size of the combined electronic device and the digital camera is increased.

Therefore, a smaller sized digital camera module is desired.

### SUMMARY OF THE INVENTION

Accordingly, an object of the present invention is to provide a digital camera module with a small size.

To achieve the above-mentioned object, a digital camera module of the present invention comprises a holder, a drawtube held by the holder, a baseboard comprising an electro-optical device and circuitry, and several conductive terminals. The electro-optical device is attached on an inside main face of the baseboard, and the circuitry is connected with the electro-optical device. The conductive terminals are provided on the holder and electrically connect with the baseboard. The digital camera module can be connected with an external device such as a portable electronic device via the terminals without the need for any extra parts. Thus a thickness and a size of the digital camera module are reduced, making it more readily inserted into devices such as mobile phones.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a digital camera module in accordance with a preferred embodiment of the present invention;

FIG. 2 is an exploded, isometric view of the digital camera module of FIG. 1;

FIG. 3 is similar to FIG. 2, but viewed from another aspect;

FIG. 4 is a top elevation of the digital camera module of FIG. 1;

FIG. 5 is a cross-sectional view taken along line V-V of FIG. 4; and

FIG. 6 is an enlarged view of a circled portion VI of FIG. 5.

### DETAILED DESCRIPTION OF THE INVENTION

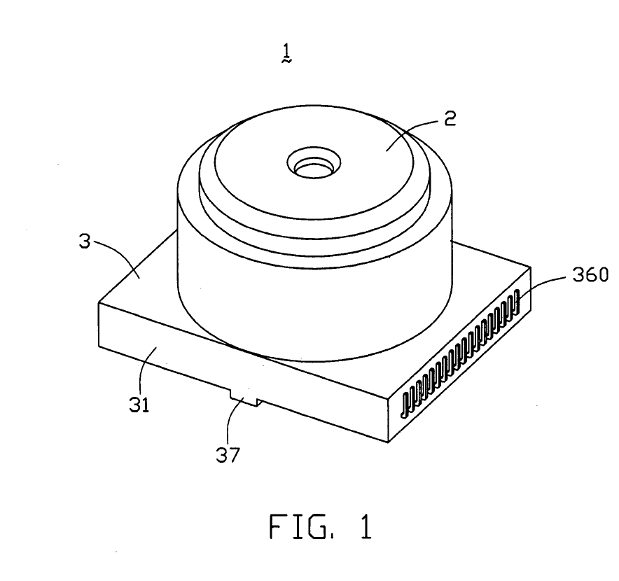

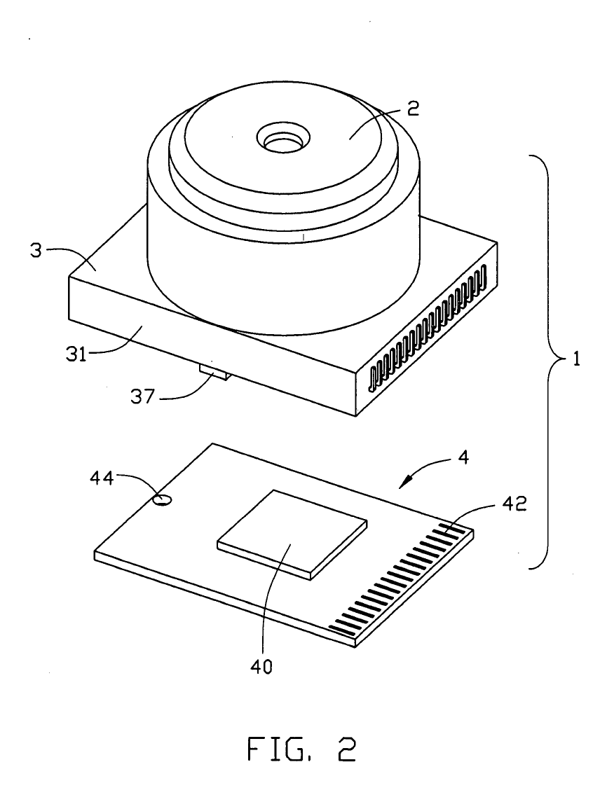

Referring to FIGS. 1 and 2, a digital camera module 1 in accordance with the preferred embodiment of the present invention comprises a drawtube 2 for accommodating at least one lens therein, a holder 3 holding the drawtube 2, and a baseboard 4 corresponding to the holder 3.

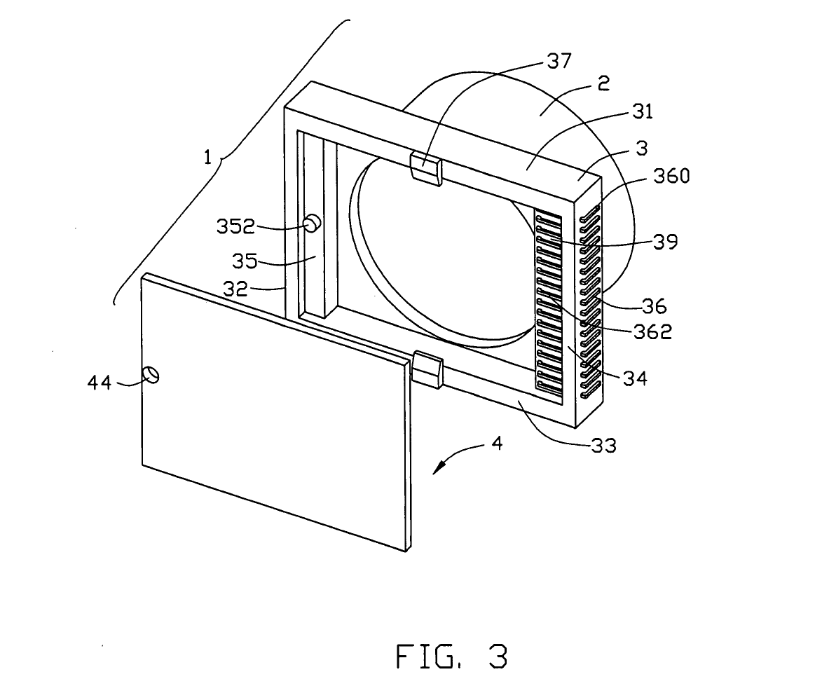

Referring also to FIG. 3, the drawtube 2 is a hollow cylinder extending from the holder 3. The drawtube 2 holds said lens, and collects incident light beams. The holder 3 is substantially a rectangular frame, and comprises an upper beam 31, a lower beam 33, a left beam 32, and a right beam 34. The upper beam 31 and the lower beam 33 each have a fastness pillar 37 formed thereon. The left beam 32 includes an inner recessed portion 35, which has a post 352 formed thereon. The right beam 34 beam includes an inner recessed portion 39. Several conductive terminals 36 are embedded in the right beam 34 and the recessed portion 39 by insert molding. The conductive terminals 36 protrude from a lateral surface of the right beam 34 thereby defining output pins 360, and protrude from a surface of the recessed portion 39 thereby defining input pins 362. The baseboard 4 is rectangular, and corresponds in size to an internal area defined by the beams 31, 32, 33, 34 of the holder 3. The baseboard 4 has an electro-optical device 40 attached on an inside main face thereof, a connector 42 embedded in a lateral side portion thereof by insert molding and corresponding to the input pins 362, a hole 44 defined in an opposite lateral side portion thereof corresponding to the post 352, and some circuitry (not shown) connecting with the electro-optical device 40 thereon.

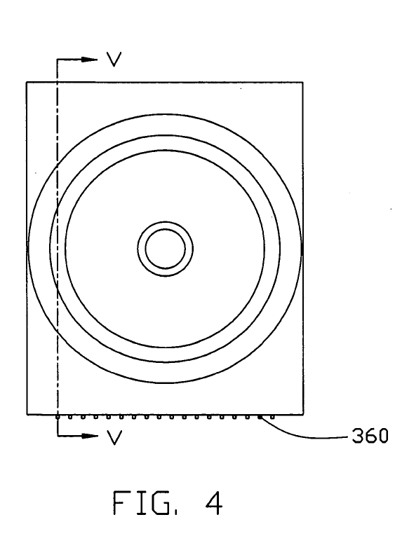

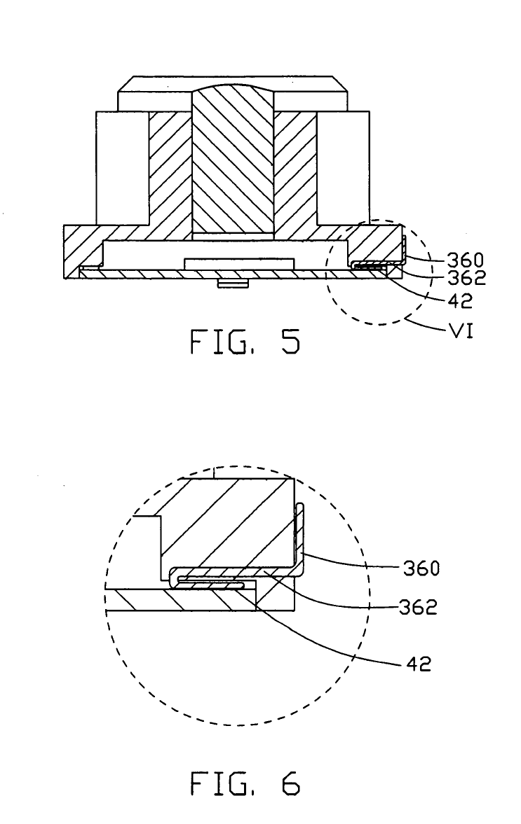

Referring to FIGS. 4, 5 and 6, in assembly, the post 352 is wedged into the hole 44, and at the same time the fastness pillars 37 snappingly engage the baseboard 4 in the holder 3. The input pins 362 of the conductive terminals 36 are thereby firmly electrically connected to the connector 42.

In use, incident light coming through the drawtube 2 and the holder 3 arrives at the electro-optical device 40 and is transformed into analog signals. The analog signals are transmitted into the circuitry (not shown) and transformed into digital signals. The digital signals are transmitted from the input pins 362 to the out-pins 360, and then to an associated external device such as a portable electronic device (not shown).

From the above description, it can be seen that the digital camera module can be connected with the external device without the need for any extra parts such as an FPC. Thus a thickness and size of the digital camera module is reduced, making it more readily inserted into devices such as mobile phones.

It is believed that the present invention and its advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

1. A digital camera module, comprising:
a holder;
a drawtube held by the holder;
a baseboard, comprising an electro-optical device and circuitry, wherein the electro-optical device is attached on an inside face of the baseboard, and the circuitry is connected with the electro-optical device; and
conductive terminals provided on the holder and electrically connected to the baseboard.

2. The digital camera module as claimed in claim 1, wherein the holder is substantially a rectangular frame comprising an upper beam, a lower beam, a left beam and a right beam, the upper beam and lower beam each having a fastness pillar thereon, the left beam and the right beam each comprising a recessed portion.

3. The digital camera module as claimed in claim 2, wherein a post is provided on the recessed portion of the left beam, and a plurality of electrical pins is embedded in the recessed portion of the right beam.

4. The digital camera module as claimed in claim 3, wherein parts of the terminals protruding from a surface of the right beam define output pins, and other parts of the terminals protruding from a surface of the recessed portion of the right beam define input pins.

5. The digital camera module as claimed in claim 3, wherein the baseboard is rectangular, and corresponds in size to an internal area defined by the four beams of the holder.

6. The digital camera module as claimed in claim 5, wherein the baseboard defines a hole corresponding to the post.

7. The digital camera module as claimed in claim 4, wherein the baseboard further comprises a connector for transmitting digital signals to the input pins.

8. The digital camera module as claimed in claim 4, wherein the output pins of the terminals are used to transmit signals to an external device.

9. A digital optical module comprising:
a holder;
a drawtube extending out of a front face of the holder;
a baseboard assembly attached to a back face of the holder, said baseboard assembly including an electro-optical device facing the drawtube, and a connection section linked to the electro-optical device via circuits; and
a plurality of conductive terminals are provided on the holder; wherein
said terminals define output ends exposed to an exterior and adapted to be mechanically and electrically engaged with an external device, and input ends hidden within the holder and mechanically and electrically connected to the connection section.

10. The digital optical module as claimed in claim 9, wherein said connection section and said input ends are mechanically and electrically engaged with each other by means of attaching the baseboard to the holder,

11. The digital optical module as claimed in claim 9, wherein said holder defines a rectangular box, and said terminals are disposed on one side thereof.

12. A method of assembling a digital optical module, comprising steps of:
providing a holder with a drawtube extending from an upper face thereof and with a plurality of terminals on at least one side thereof wherein said terminals define output ends exposed to an exterior for connection with an external device and input ends essentially hidden in the holder;
providing a baseboard with an electro-optical device and a connection section electrically connected to each other via circuits; and
attaching said baseboard to a lower face of the holder to have the electro-optical device aligned with the drawtube and have the input ends of the terminals mechanically and electrically engaged with the connection section.
